(19) United States
(12) Patent Application Publication
(10) Pub. No.: US 2015/0025857 A1
(43) Pub. Date: Jan. 22, 2015

(54) STATISTICAL POWER ESTIMATION

(71) Applicant: International Business Machines Corporation, Armonk, NY (US)

(72) Inventors: Igor Arsovski, Williston, VT (US); Robert M. Houle, Williston, VT (US); Mark W. Kuemerle, Essex Junction, VT (US)

(73) Assignee: International Business Machines Corporation, Armonk, NY (US)

(21) Appl. No.: 13/947,155

(22) Filed: Jul. 22, 2013

(51) Int. Cl. G06F 17/50

(52) U.S. Cl. CPC G06F 17/5045
USPC 703/2

(57) ABSTRACT

A method for predicting the power consumption of a semiconductor chip is provided. A plurality of statistical distributions characterizing a plurality of power contributing parameters for a plurality of power consuming units included in the semiconductor chip is received. A statistical distribution characterizing the power consumption is determined based on the received plurality of statistical distributions and based on the correlation between the plurality of power contributing parameters.

### BACKGROUND

### Field of the Invention

The present invention relates to circuit analysis, and more particularly, to a statistical approach for estimating power consumption.

Power consumption is becoming an increasing concern in the design of integrated circuits (ICs), particularly for very large scale integration (VLSI) chip designs. To address this concern many design tools have been developed to measure or estimate power consumption in VLSI designs. The estimated power consumption is employed to help designers meet target power parameters and ultimately facilitate design convergence.

Techniques used to estimate switching activities associated with power consumption in VLSI chips include simulation-based techniques and statistics-based techniques. For both types of techniques, the dynamic power consumption of a circuit is computed based on estimated switching activities of a circuit or a defined part of a circuit. In particular, power consumption is proportional to the switching activities and the associated capacitance at respective nodes of the circuit.

Statistics-based approaches to power estimation can often achieve greater accuracy over simulation-based approaches because most simulation-based techniques focus on worst case performance of the electrical circuit. Worst case performance is determined by analytically selecting the worst combination of conditions that the circuit (or circuit design) can experience during its operational lifetime. In this way the worst case analysis produces an inaccurate estimate of power consumption, which may lead to increased cost and lower efficiency of the integrated circuit.

### SUMMARY

In an aspect of the invention, a method for predicting the power consumption of a semiconductor chip includes receiving a plurality of statistical distributions characterizing a plurality of power contributing parameters and their respective statistical correlation for a plurality of power consuming units included in the semiconductor chip. The method further includes determining a statistical distribution characterizing the power consumption based on the received plurality of statistical distributions and based on the correlation between the power contributing parameters.

In another aspect, a computer program product for predicting the power consumption of a semiconductor chip is provided. The computer program product includes one or more computer-readable storage devices and a plurality of program instructions stored on one or more computer-readable storage devices. The plurality of program instructions include program instructions to receive a plurality of statistical distributions characterizing a plurality of power contributing parameters and their respective statistical correlation for a plurality of power consuming units included in the semiconductor chip. The plurality of program instructions further include program instructions to determine a statistical distribution characterizing the power consumption based on the received plurality of statistical distributions and based on the correlation between the power contributing parameters.

In yet another aspect, a computer system for predicting the power consumption of a semiconductor chip is provided. The computer system includes one or more processors, one or more computer-readable storage devices, and a plurality of program instructions stored on one or more storage devices for execution by one or more processors. The plurality of program instructions include program instructions to receive a plurality of statistical distributions characterizing a plurality of power contributing parameters and their respective statistical correlation for a plurality of power consuming units included in the semiconductor chip. The plurality of program instructions further include program instructions to determine a statistical distribution characterizing the power consumption based on the received plurality of statistical distributions and based on the correlation between the power contributing parameters.

A more complete understanding of the present invention, as well as further features and advantages of the present invention, will be obtained by reference to the following detailed description and drawings. It is to be understood that both the foregoing general description and the following detailed description are exemplary and explanatory only, and should not be considered restrictive of the scope of the invention, as described and claimed. Further, features or variations may be provided in addition to those set forth herein. For example, embodiments of the invention may be directed to various combinations and sub-combinations of the features described in the detailed description.

### BRIEF DESCRIPTION OF THE SEVERAL VIEWS OF THE DRAWINGS

The present invention is described in the detailed description which follows in reference to the noted plurality of drawings by way of non-limiting examples of exemplary embodiments of the present invention.

FIG. 1 is an illustration of a distributed data processing environment for predicting the power consumption of a semiconductor chip in accordance with an embodiment of the present invention;

FIG. 2 illustrates a table of parameters in the exemplary parameters repository in FIG. 1, according to an embodiment of the present invention;

FIG. 3 is an exemplary graph illustrating a model to hardware correlation for a dynamic power component;

FIG. 4 illustrates steps performed by a parameter collector program and by a statistical analyzer program for predicting the power consumption of a power consuming unit, according to an embodiment of the present invention;

FIGS. 5A-5D are graphs illustrating exemplary histograms characterizing probability distributions for some of the parameters affecting power consumption;

FIG. 6 is a graph illustrating representative statistical distribution of a leakage power parameter affecting power consumption, according to an embodiment of the present invention;

FIG. 7 is a graph illustrating a representative statistical distribution of a total power consumed by a power consuming unit generated by statistically varying a plurality of the power contributing parameters during Monte Carlo simulation, according to an embodiment of the present invention;

FIG. 8 is a graph illustrating representative statistical distributions of a total power consumed by a power consuming unit generated by statistically varying a plurality of the power contributing parameters, one parameter at a time, during Monte Carlo simulation, according to another embodiment of the present invention;

FIG. 9 is a block diagram of internal and external components of each of the computers of FIG. 1; and

FIG. 10 is a source code listing in the Perl programming language which may be utilized by the statistical analyzer program of FIG. 1 to perform a Monte Carlo simulation, according to an embodiment of the present invention.

### DETAILED DESCRIPTION

An embodiment of the present invention relates to a method for predicting the power consumption of a semiconductor chip. Power consumption from the complimentary metal oxide semiconductor (CMOS) integrated circuits commonly used to build electronic devices consists of two components: dynamic (active) power consumption and static (leakage) power consumption. Dynamic power consumption refers to the amount of power required to operate (i.e., switch) a device. Dynamic power consumption is a function of capacitance, voltage, and switching frequency. That is P=C*V²*F, where P is the dynamic power, C is the effective switch capacitance, V is the supply voltage and F is the switching frequency. Static power consumption refers to the amount of power consumed by the device when it is not operating (i.e., OFF) and is also an exponential function of the supply voltage. In the past static power consumption was an insignificant portion of overall power consumption. However, with device scaling the ratio of static to dynamic power making up overall power consumption has increased. Thus, optimizing not only dynamic power consumption but also static power consumption is now a major concern for designers of advanced integrated circuits (ICs).

In addressing the issue of static power consumption, designers have realized that manufacturing variations are a critical problem. Specifically, manufacturing variations may cause one or more parameters to vary between integrated circuits that are formed according to the same design. These variations can affect chip operating frequency (i.e., switching speed). For example, due to variations in the equipment, operators, positions on a wafer, etc., a specific parameter may vary between chips built on the same wafer, chips built on different wafers in the same lot and/or chips built on different wafers in different lots. If this parameter is, for example, line width, then the channel width of the transistors on each chip may be different such that the performance varies (e.g., faster or slower). Chips that are fabricated either at the “slow” end or the “fast” end of a process distribution (e.g., a process-temperature-variation (PVT) space) may not be desirable. For example, chips that are fabricated at the “slow” end of such a process distribution may not meet the desired performance specification (i.e., may not have a fast enough switching speed), whereas chips fabricated at the “fast” end of this process distribution may exhibit excessive power and leakage current.

In an aspect of the invention, a method for predicting the power consumption of a semiconductor chip includes receiving a plurality of statistical distributions characterizing a plurality of power contributing parameters for a plurality of power consuming units included in the semiconductor chip. The method further includes analyzing correlation between the power contributing parameters. The method further includes determining a statistical distribution characterizing the power consumption based on the received plurality of statistical distributions and based on the analyzed correlation between the power contributing parameters.

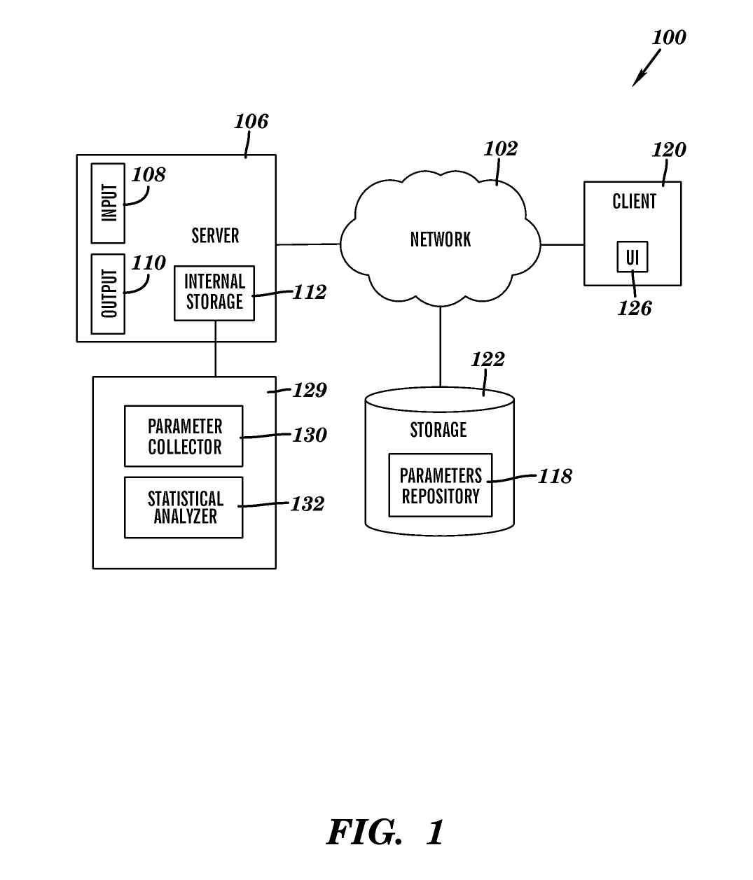

Thus, the illustrative embodiments may be utilized in many different types of data processing environments including a distributed data processing environment, a single data processing device, or the like. In order to provide a context for the description of the specific elements and functionality of the illustrative embodiments, FIG. 1 is provided hereafter as example environment in which aspects of the illustrative embodiments may be implemented. It should be appreciated that FIG. 1 is only an example and is not intended to assert or imply any limitation with regard to the environments in which aspects or embodiments of the present invention may be implemented. Many modifications to the depicted environments may be made without departing from the spirit and scope of the present invention.

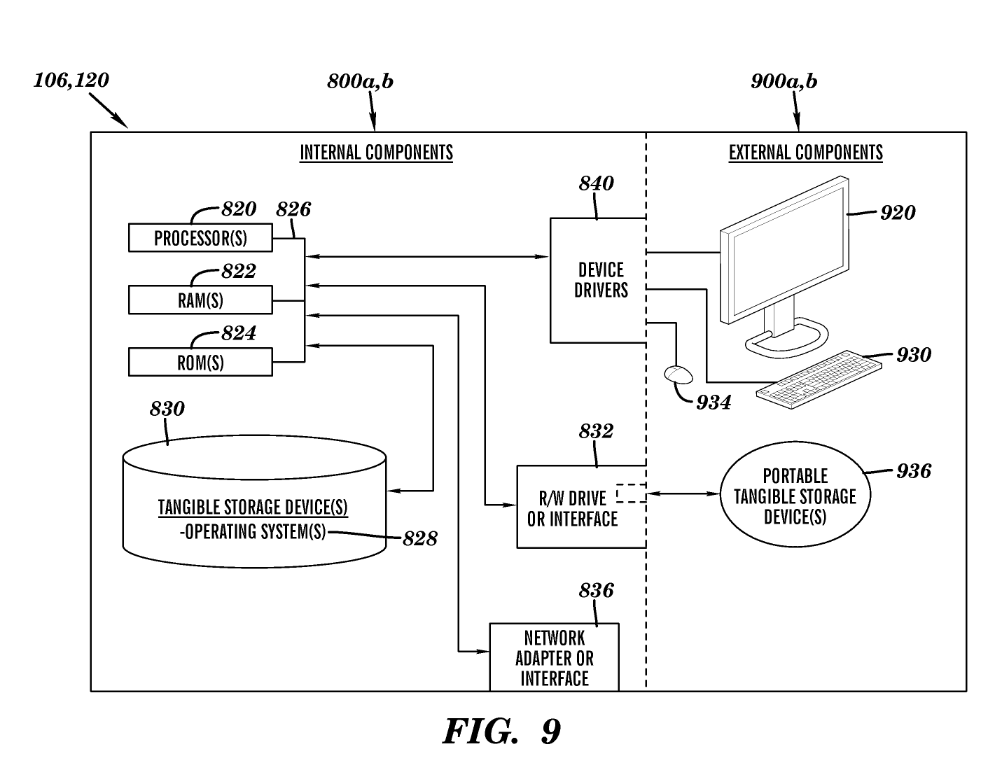

With reference now to the figures, FIG. 1 depicts a pictorial representation of an example distributed data processing system in which aspects of the illustrative embodiments may be implemented. Distributed data processing environment 100 includes client computer 120 coupled to a server computer 106 and storage unit 122 via a network 102 such as the Internet. As will be discussed with reference to FIG. 9, server computer 106 includes internal components 800a and external components 900a and client computer 120 includes internal components 800b and external components 900b. For simplicity purposes, only one client computer 120 is shown in FIG. 1, although in other embodiments, distributed data processing environment 100 can include additional client computers.

Network 102 represents a worldwide collection of networks and gateways that use the Transmission Control Protocol/Internet Protocol suite of protocols to communicate with one another. At the heart of the Internet is a backbone of high-speed data communication lines between major nodes or host computers consisting of thousands of commercial, governmental, educational and other computer systems that route data and messages. Alternatively, the computers and other devices of distributed data processing environment 100 may be interconnected by different types of networks, such as an intranet, a local area network (LAN), or a wide area network (WAN). Network 102 may include communication connections, such as wire, wireless communication links, or fiber optic cables. Client computer 120 may be, for example, a mobile device, a telephone, a personal digital assistant, a netbook, a laptop computer, a tablet computer, a desktop computer, or any type of computing devices capable of hosting a user interface (UI) 126, such as an interface for gathering various power contributing parameters from a user, as described below. Typically, UI 126 displays information via a display device 920 (shown in FIG. 9) of external components 900b (shown in FIG. 9), such as a monitor, a laptop screen, television, or the like, and receive input from the user (as described below, for example) via one or more input devices of external components 900b, which can include, without limitation, a keyboard 930, a mouse 934, a trackball, a digitizing tablet, or the like. Client computer 120 may display and/or otherwise render a representation of a statistical distribution of the power consumption generated, for example, by a power predictor application program 129.

The UI 126 may preferably store collected information in the parameters repository 118. The parameters repository 118 may be kept in the internal storage 112 of the server computer 106 or in the storage unit 122, as shown in FIG. 1. In some embodiments the parameters repository 118 may be a document repository in a cloud computing environment. In an embodiment, the parameters repository 118 may represent a data source, such as a database. For simplicity purposes, only one parameters repository 118 and one storage unit 122 are shown in FIG. 1, although in other embodiments, the distributed data processing environment 100 can include additional data sources and additional storage units. The client computer 120 is client to the server computer 106 in this example. The server computer 106 may contain an input device 108 and an output device 110.

The server computer 106 may include a power predictor application program 129. The power predictor application program 129, located in the distributed data processing environment 100, may comprise program instructions stored on one or more computer-readable tangible storage devices, which may include the internal storage 112 on the server computer 106. Various components of the power predictor application program 129 may communicate via local and/or remote processes, such as in accordance with a signal having one or more data packets (for example, but not limited to, data from one program interacting with another program in a local system, distributed system, and/or across the network 102 with other systems via the signal). Data gathered, generated, and maintained for use by the power predictor application program 129 may be kept in the internal storage 112 of the server computer 106 or in one or more parameter repositories 118 of the storage unit 122.

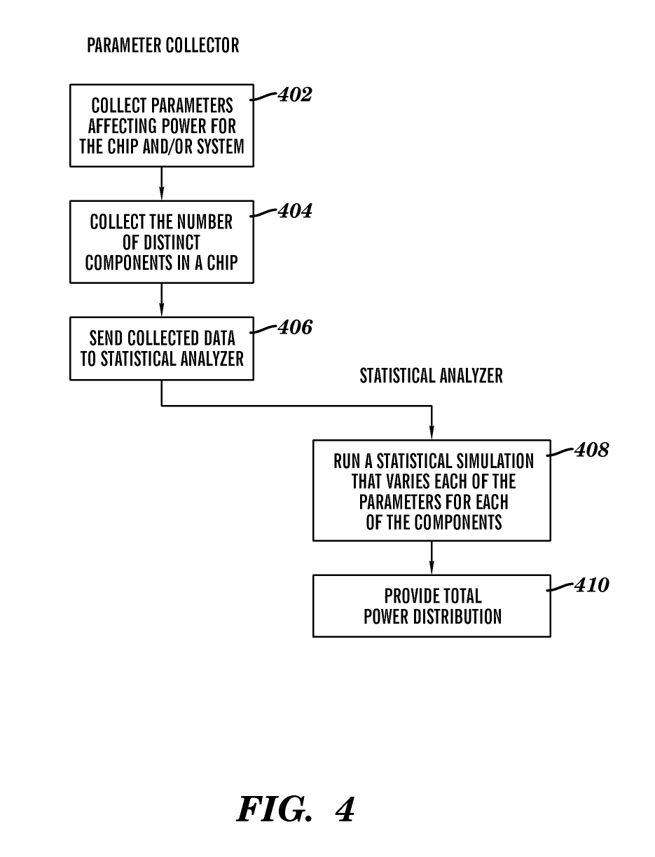

The power predictor application program 129 may include various programs or program components, such as the parameter collector program 130 and the statistical analyzer program 132. The parameter collector program 130 may be, for example, a computer program or program component for searching information stored in the parameters repository 118 based on a configuration of a unit for which the power consumption should be estimated, as discussed below in conjunction with FIG. 4. The statistical analyzer program 132 may be, for example, a computer program or program component for generating a statistical distribution of the power consumption based on the received plurality of statistical distributions of power contributing parameters and based on the analyzed correlation between the plurality of power contributing parameters as discussed below in conjunction with FIGS. 4-8. The parameter collector program 130 and statistical analyzer program 132 reside within the presentation power predictor application program 129 and may be localized on the server 106 and/or distributed between two or more servers.

In the illustrated example, data is communicated between the server computer 106 and the client computers 120 using a standard protocol such as Hyper Text Transfer Protocol (HTTP), File Transfer Protocol (FTP), Simple Object Access Protocol (SOAP) over HTTP, or the like. The distributed data processing environment 100 may include additional server computers, client computers, displays and other devices not shown.

A major element in the qualification of any new semiconductor technology, circuit element, or product is a model to hardware correlation (MHC). An MHC is an exhaustive process that involves comparing a software based simulation of several devices (e.g., circuits) with the hardware performance of the same device or circuit. This activity allows circuit designers, technology developers and EDA (Electronic Design Automation) tools developers to find any mismatch between the technology specifications and the end product delivered from the manufacturing facility. Any mismatch is addressed and a further MHC is pursued to verify the solution.

An MHC is fairly simple if all the process parameters are run at exactly nominal conditions. However, the manufacturing line only guarantees that each parametric parameter will be in a certain range. The overall range of all of these parameters is called the “Process Window”. Often qualification engineers wish to evaluate the MHC at corners of the Process Window that are artificially skewed away from nominal conditions. For example, several lots of test sites may be run with artificially long channel lengths to evaluate if the device model is still accurate in case the manufacturing line allows channel length to run a bit too long. In order to perform MHC on this hardware, the artificially long channel length must be accounted for in the software simulation.

One of the main conventional processes to evaluate MHC is a Best Case/Worst Case Analysis. This allows designers to see the overall margin in their designs by simulating best and worst case hardware, and comparing to the fastest and slowest hardware that the manufacturing line would deliver to a customer. The problem with this analysis is it simply reflects if the amount of bounding in simulation is adequate for the process variations in manufacturing. This type of analysis does not pinpoint individual process parameters and their effect on circuit performance.

Various embodiments of the invention described herein allow for the incorporation of individual power contributing parametric data into a circuit simulation. The simulation can be tailored to reflect the power consumption and behavior of a specific power consuming unit, by running several power-specific simulations of this type and comparing the results to the respective devices, one ordinarily skilled in the art can accurately pinpoint the circuit sensitivities to individual power affecting parameters (also referred to herein as power contributing parameters). The MHC attempts to match the behavior and performance of the specific devices, instead of bounding the timing with Best Case/Worst Case analysis.

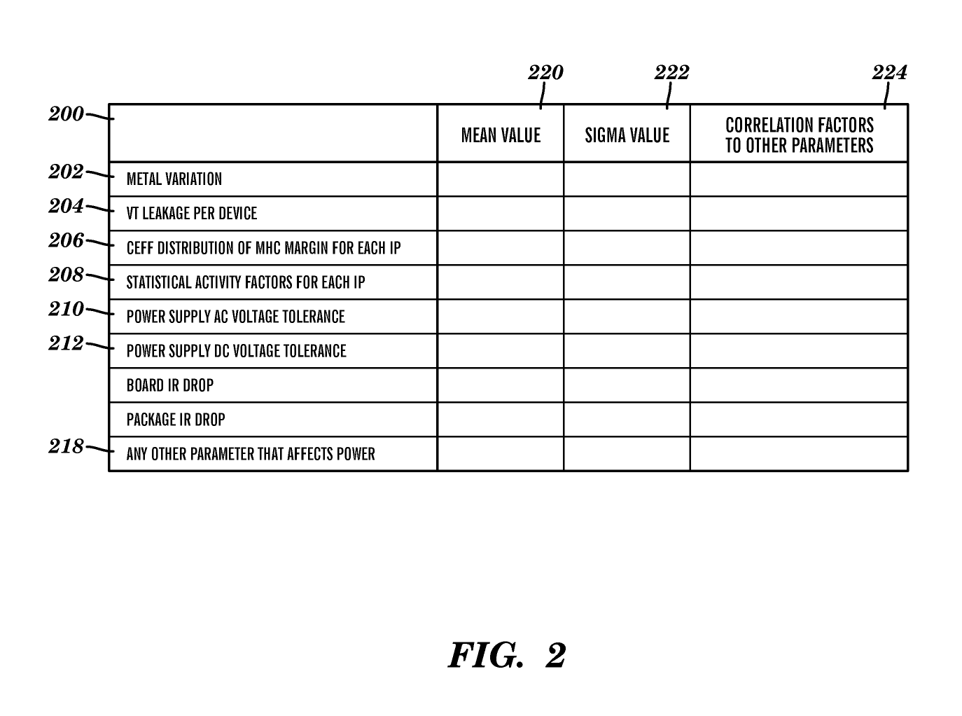

FIG. 2 illustrates a table of parameters 200 which may be contained in the exemplary parameters repository 118 in FIG. 1, according to an embodiment of the present invention. One parameter affecting power is Vt (threshold voltage) leakage 204. Different sources of physical variability largely affect Vt leakage parameter 204 and thus may increase the mean value 220 and standard deviation value 222 of total leakage in scaled technologies. For example, low-Vt transistors offer fast speed but have high leakage, whereas high-Vt transistors have reduced speed but far less leakage current. At elevated ambient temperatures, semiconductor leakage current 204 increases exponentially with temperature which results in increased static device power dissipation. Furthermore, process variations introduced at different stages of semiconductor device fabrication may also increase Vt leakage parameter 204 exponentially. Another parameter affecting power consumption may include a metal variation 202 (or any other process variation) resulting from IC fabrication.

As previously indicated, power consumption consists of two components: static (leakage) power consumption and dynamic (active) power consumption. Dynamic power consumption is a function of capacitance, voltage, switching frequency and various activity factors described below. Dynamic power consumption for an integrated circuit can be modeled by the following formula:

P=C×V²×F×AF (1)

where P=dynamic power consumption, C=switched capacitance, V=switching voltage, F=switching frequency, and AF=activity factor.

Therefore, the table of parameters 200 may include a C_{eff} distribution of MHC margin for each power consuming unit 206 (such as an IP block), where C_{eff} is the effective switching capacitance and MHC is model to hardware correlation. As used herein, an IP block is representative of a block or logical group of circuitry that typically serves one or more targeted functions (e.g. SRAM cell, DRAM cell, analog to digital converters, and the like). IP blocks are also referred to herein as functional blocks. The activity factor is a relationship of activity within an IP block. Thus, the activity factor concerns how often out of N cycles a certain portion of an IP block switches high/low or low/high. In an exemplary embodiment described herein, the statistical activity factors 208 may be included in the parameter table 200. Since both dynamic power consumption and static power consumption are greatly affected by voltage, another characteristic that may be included in the table of parameters 200 is power supply voltage tolerance, which refers to the accuracy of the voltage level provided by the power supply. At least in some embodiments two different parameters may characterize voltage, such as power supply AC voltage tolerance 210 and power supply DC voltage tolerance 212. Embodiments of the present invention contemplate that the table of parameters 200 may include any other parameter that affects power 218. Furthermore, embodiments of the present invention contemplate that for each of the power affecting parameters described above users may provide a few statistical characteristics, such as a mean value 220, a standard deviation value 222 and correlation factors 224 between the provided parameters. In one embodiment, the table of parameters 200 may be populated and updated by users via the UI 126 shown in FIG. 1.

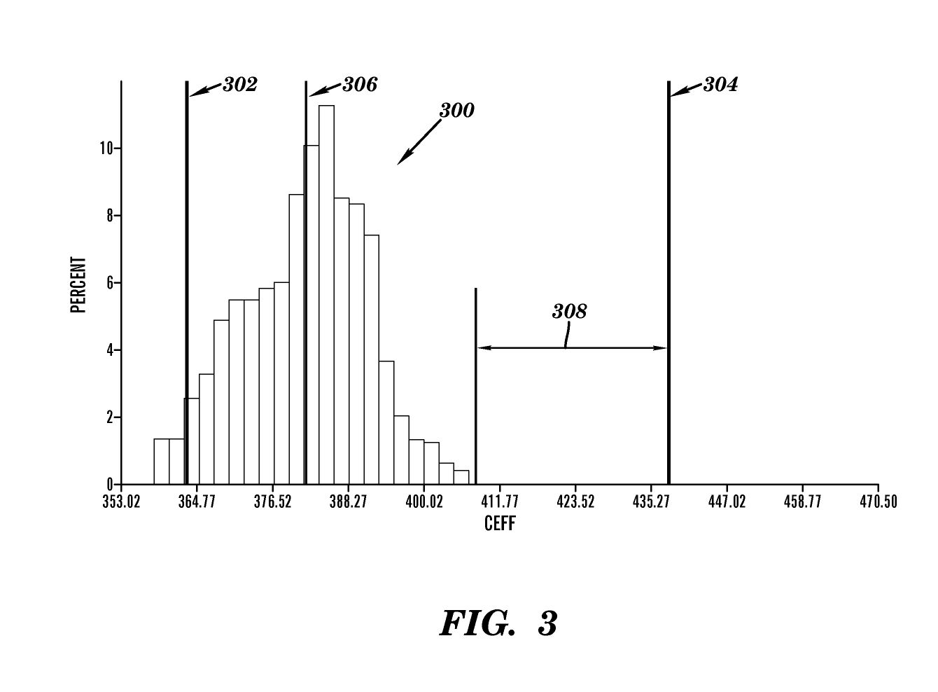

FIG. 3 is an exemplary graph illustrating a model to hardware correlation for a dynamic power component. Embodiments of the present invention contemplate that a histogram 300 may be generated using conventional statistical modeling techniques. The histogram 300 shown in FIG. 3 is a graphical representation of the distribution of C_{eff} (effective switching capacitance) continuous variable for a particular power consuming unit. Switching capacitance for a particular power consuming unit can be modeled by the following formula:

C_{eff}=I/V×F (2)

where C_{eff}=switched capacitance, V=switching voltage, and F=switching frequency.

The histogram 300 shown in FIG. 3 may have a substantially Gaussian shape (representing substantially normal distribution). Switched capacitance values C_{eff} are provided on the X-axis based on the obtained measurements. The Y-axis shows the percentage of measurements corresponding to particular values of the C_{eff} variable. For the histogram 300, the mean value 306 characterizing the distribution may be equal to approximately 380 pF. Vertical lines 302 and 304 represent dynamic power estimates that may be given as a specification to a client intended to use the particular power consuming unit for which the model has been generated. Vertical lines 302 and 304 represent acceptable bounds for the dynamic power characterization as determined by a conventional statistical model. In the example shown in FIG. 3 the acceptable values for C_{eff} parameter 206 may range from approximately −5% deviation 302 from the mean value 306 to approximately +15% deviation 304 from the mean value 306. As illustrated in FIG. 3, the upper boundary for acceptable values, such as vertical line 304 may exceed the highest measurement in the actual distribution of the continuous variable (in this case C_{eff}) by a substantial variable margin 308. This variable margin 308 makes the conventional worst case analysis estimation technique significantly inaccurate, which may lead to overestimation of dynamic power requirements and thus may lead to inefficient power sources.

Recognizing the importance of power estimation, inventors have investigated power estimation technique ranging from the circuit level up to the system level. Various embodiments of the present invention introduce advantageous simulation-based logic-level power estimation techniques for CMOS integrated circuits. One exemplary implementation of such simulation technique is described below in conjunction with FIGS. 4-8.

FIG. 4 illustrates steps performed by the parameter collector program 130 and by the statistical analyzer program 132 for predicting the power consumption of a power consuming unit, according to an embodiment of the present invention. The power predictor application program 129 may include various programs or program components, such as the parameter collector program 130 and the statistical analyzer program 132. The parameter collector program 130 may be, for example, a computer program or program component for searching information stored in the parameters repository 118 based on a configuration of a power consuming unit for which the power consumption should be predicted. The statistical analyzer program 132 may be, for example, a computer program or program component for generating a statistical distribution of the power consumption based on the received plurality of statistical distributions and based on the analyzed correlation between the power contributing parameters. In various embodiments, the power application program 129 may utilize a power estimation technique capable of scaling power consumption ranging from the chip level up to the system level.

At 402, the parameter collector program 130 may obtain parameters affecting power for a given chip and/or system. The data may be any observed or user entered data about the environment behavior. In some cases, the raw data may be aggregated, summarized, synthesized, or otherwise processed prior to sending it to the statistical analyzer program 132. For example, in response to receiving the plurality of statistical distributions, the parameter collector program 130 may extract statistical characteristics of the respective statistical distributions, such as mean and standard deviation values of the respective statistical distributions. The collected data may be power related parameters, as well as other input parameters. In many cases, large amounts of raw data may be collected by the parameter collector program 130 and then analyzed to identify those parameters and/or parameter characteristics that may be related to power consumption metrics as well as too identify the correlation between the parameters if such correlations have not been provided by the collected data.

The parameter collector program 130 may use various mechanisms, including real time and delayed mechanisms to collect and store the power affecting parameters data. If real time mechanism is implemented, the parameter collector program 130 may receive data at or near the time the data is collected from a user by, for example, UI program 126 running on the client computer 120. In such cases, the parameter collector program 130 may optionally process the collected data and send it to the statistical analyzer program 132 (at 406) or, alternatively, may store the collected data, for example, in the parameters repository 118 kept in the storage unit 122. In an embodiment of the present invention, the collected parameters data may be stored in a table such as the parameters table 200 illustrated in FIG. 2. In an embodiment of the present invention, the parameter collector program 130 may tag the collected parameters data with various metadata, such as timestamps, data source, chip ID, and the like.

In another embodiment of the present invention, the parameter collector program 130 may be implemented using a delayed data collection mechanism. For example, the UI program 126 may write data directly to the parameters repository 118 (shown in FIG. 1). Then the parameter collector program 130 may collect the data for processing from the parameters repository 118 at a later time. In such implementation, the collected data may be timestamped or otherwise tagged for correlation with other data collected using similar or different data collection mechanisms.

At 404, the parameter collector program 130 may collect information about a power consuming unit, such as, for example, but not limited to, a chip or a system to be analyzed depending on a level of analysis requested by a user. In an embodiment of the present invention, the data collected in this step may include, for example, but not limited to a number of distinct IP blocks in the analyzed chip and/or system, the number of boards in a system, the number of ICs on a board, their individual contributions to the total power, the characterization margins when MHC was closed, and the like. In an embodiment of the present invention, the number of distinct IP blocks in the analyzed power consuming unit may be provided by a user, while their individual contributions to the overall power consumption and the characterization margins when MHC was closed may be calculated by the parameter collector program 130.

At 406, the parameter collector program 130 may transfer collected data to the statistical analyzer program 132. In various embodiments of the present invention, the parameter collector program 130 may either retrieve the data from the parameters repository 118 or may receive the parameters data from the UI program 126.

At 408, the statistical analyzer program 132 may perform a numerical analysis (simulation) of the data received from the parameter collector program 130. In an embodiment of the present invention, the statistical analyzer program 132 may employ Monte Carlo simulations to analyze power affecting parameters in order to obtain improved power efficiency at a chip level and/or at a system level.

Simulation techniques called Monte Carlo methods are well known in the art which include a class of computational algorithms for simulating the behavior of various physical and mathematical systems. Such Monte Carlo methods are distinguished from other simulation methods by being stochastic, i.e., non-deterministic in some manner, usually by using random numbers or pseudo-random numbers, as opposed to deterministic algorithms. Because of the repetition of algorithms and the large number of calculations involved, Monte Carlo methods are suited to calculation using a computer, utilizing many techniques of computer simulation. It is recognized that the amount of uncertainty provides an avenue to explain an incorrect prediction. Quantification of the uncertainty boundaries by forward modeling utilizing Monte Carlo simulations overcomes these limitations. The main improvements of various embodiments of the present invention are that the uncertainties in all measurements and parameters are accounted for using numerical analysis, i.e. Monte Carlo simulation. In an embodiment of the present invention, the statistical analyzer program 132 may generate statistical distributions for total power consumption based on the power-affecting parameter values provided by the parameter collector program 130.

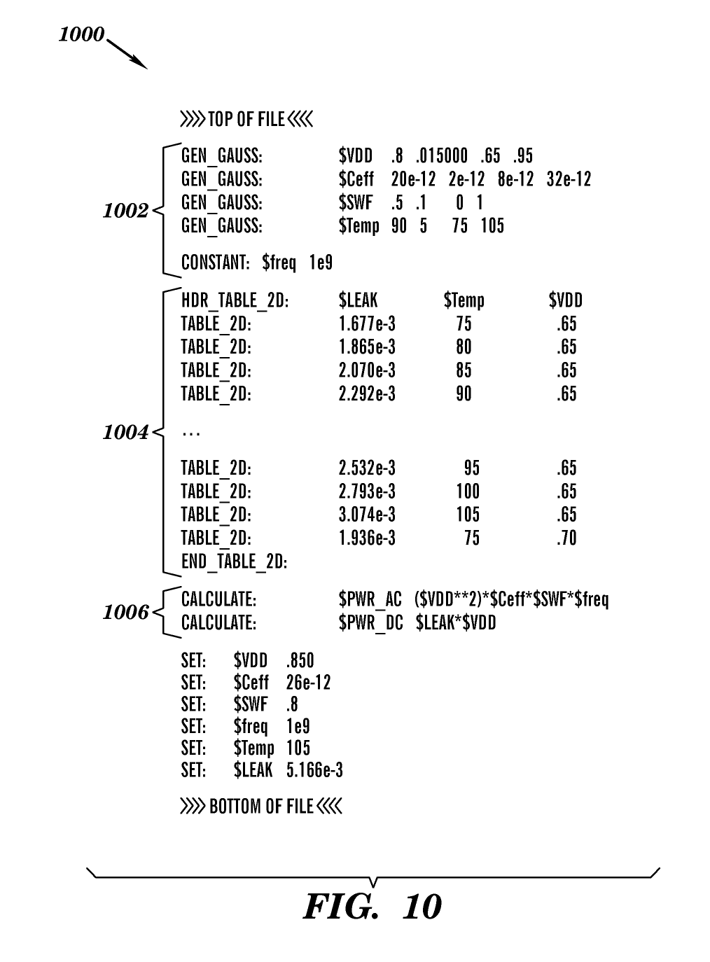

FIG. 10 is a listing of the control file for an exemplary Perl program that may be used by the statistical analyzer program 132 to perform a Monte Carlo simulation. The exemplary Monte Carlo program 1000 may employ the random number generation technique to calculate the total power distribution for a given chip and/or system. First section 1002 of the Monte Carlo program 1000 defines the power affecting parameters and their distributions. As shown in FIG. 10, the parameters may include an optimal supply voltage (Vdd) having a normal distribution (μ=0.8V and σ=15 mV), effective capacitance (C_{eff}) having a normal distribution (μ=20 pF and σ=2 pF), active factor (switching factor SWF) having a normal distribution (μ=0.5 and σ=0.1), temperature having a normal distribution (μ=90°, σ=5°), and a frequency (Freq) may be a constant parameter equal to 1 GHz. Second section 1004 of the Monte Carlo program 1000 illustrates that a power leakage parameter may be interpolated from a table as a function of temperature and voltage, where temperature values range between approximately 75° and approximately 105° (step=5° and where VDD values range between approximately 0.65 mV and approximately 0.95 mV (step=0.05 mV). Third section 1006 of the Monte Carlo program 1000 defines equations for AC power and DC power as:

AC=Vdd²*C_{eff}*SWF*Freq (3) and

DC=Vdd*Leakage (4).

Third section 1006 generates random parameters based on the specified distributions and calculates AC power and DC power using equations (3) and (4). In an embodiment of the present invention, the statistical analyzer program 132 may run the Monte Carlo program 1000 for approximately 100,000 trials allowing each of the specified power affecting parameters to vary.

Referring back to FIG. 4, at 410, the statistical analyzer program 132 may render and/or otherwise display the calculated statistical distributions for total power consumption to a user via, for example, the UI program 126. Alternatively, the statistical analyzer program 132 may store the calculated distribution in the storage unit 122. The statistical (numerical) analysis methodology presented herein produces a powerful analytical prediction of the variation of power consumption based on the known characteristics of the design and the demanding environments in which it operates.

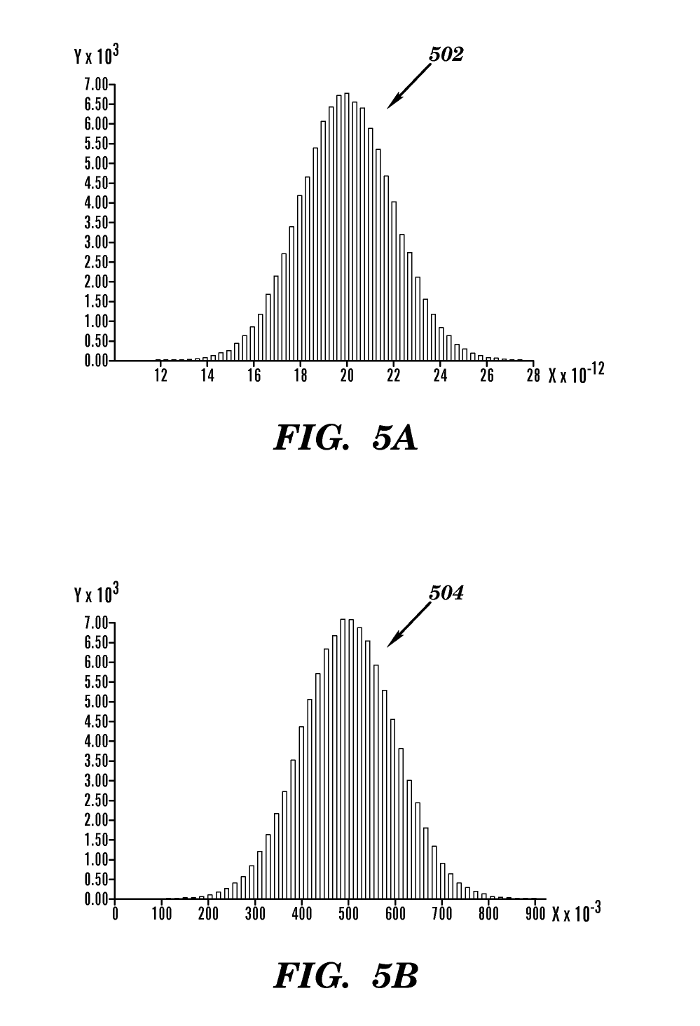

FIGS. 5A-5D are graphs illustrating exemplary histograms characterizing probability distributions for some of the parameters affecting power consumption. For example, FIG. 5A depicts a distribution of the effective capacitance 502, as defined in the first section 1002 of the Monte Carlo program 1000. Similarly, FIG. 5B shows a distribution of the switching frequency 504, as defined in the first section 1002 of the Monte Carlo program 1000. FIGS. 5C and 5D illustrate probability distributions for the optimal supply voltage parameter (Vdd) 506 and for the temperature parameter 508, respectively. As shown in FIGS. 5A-5D, the Monte Carlo simulation program 1000 assumes substantially normal distribution for most of the power-affecting parameters. However, other statistical distributions for example, but not limited to, a Uniform Distribution, a Weibull distribution, a Gumbel Distribution could also be implemented.

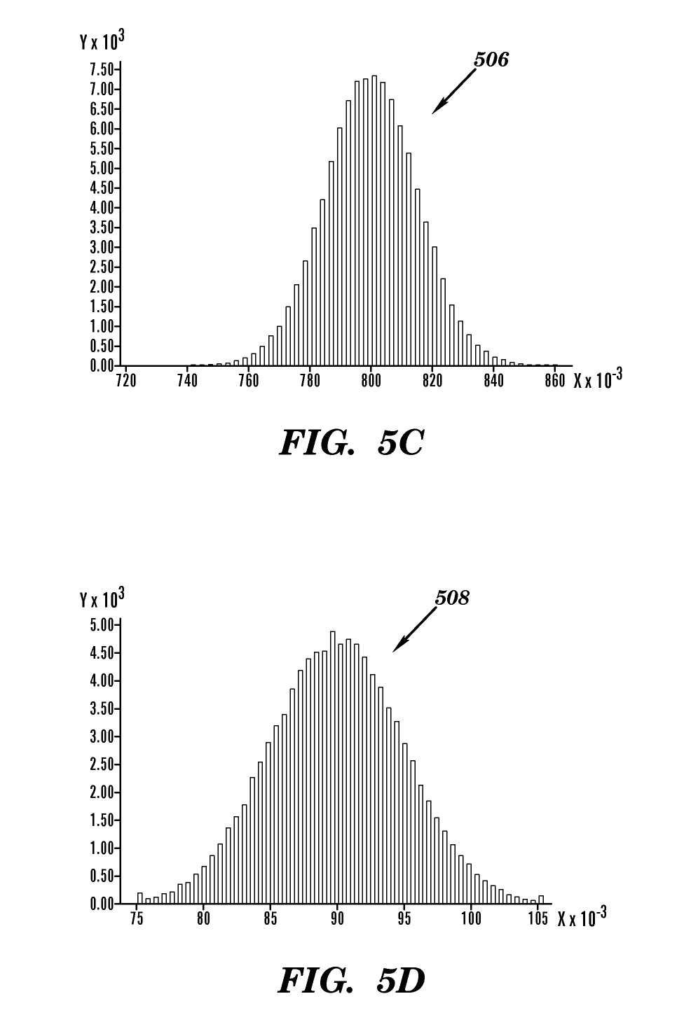

FIG. 6 is a graph illustrating a distribution characterizing a leakage power parameter 602, defined in the second section 1004 of the Monte Carlo program 1000. Due to higher granulation and tabular evaluation of data for the leakage power as evidenced by the table defined in the second section 1004 (see FIG. 10), the distribution of the leakage power 602 is not Gaussian, however, this distribution also has a corresponding mean and standard distribution values.

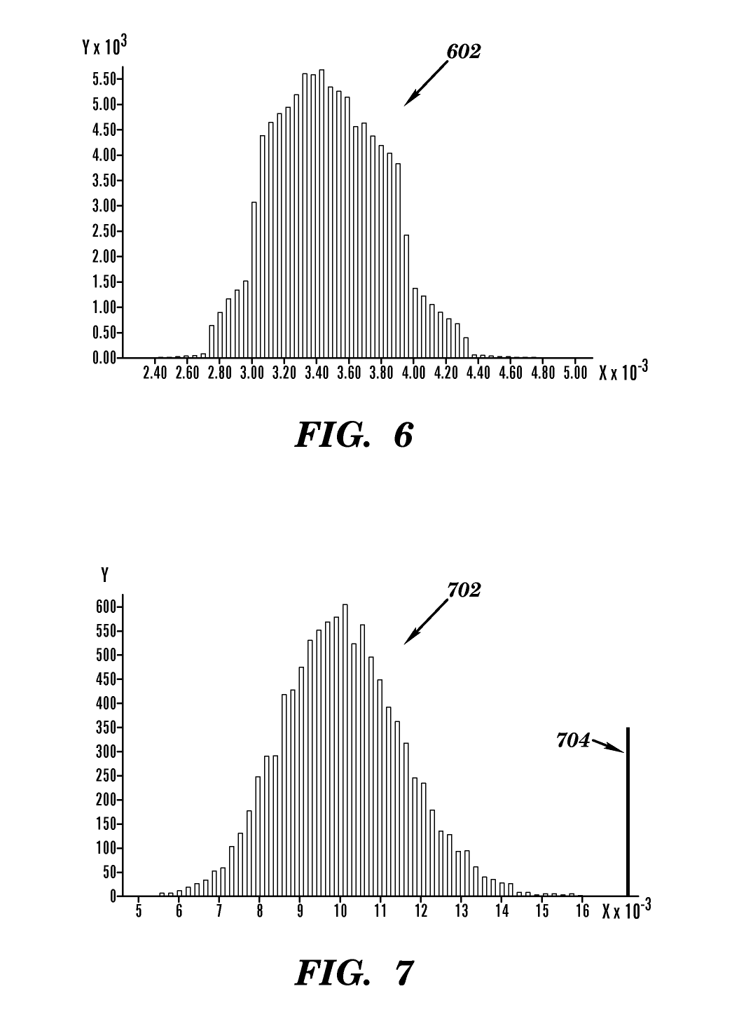

FIG. 7 is a graph illustrating a representative statistical distribution of a total power consumed by a power consuming unit generated by statistically varying a plurality of the power contributing parameters during Monte Carlo simulation, according to an embodiment of the present invention. In an embodiment of the present invention, the statistical analyzer program 132 may generate statistical distributions for total power consumption based on the power-affecting parameter values provided by the parameter collector program 130 by employing the Monte Carlo program 1000 shown in FIG. 10. The statistical distribution of the total power parameter 702 may be generated by statistically varying a plurality of the power contributing parameters during Monte Carlo simulation, according to an embodiment of the present invention. As shown in FIG. 7, even though not all power affecting parameters have normal distribution, the total power distribution 702 may still be characterized by a normal distribution. The mean value of the exemplary total power consumption distribution 702 calculated by the statistical analyzer program 132 is equal to 9.19 mW and the standard deviation value may is equal to 1.536 mW. It should be noted that this characterization of the total power consumed by a power consuming unit is substantially different from the conventional worst case analysis value (where all parameters are at their 3 sigma values) 704 of the total power consumption, which is equal to 19.4 mW for the example shown in FIG. 7.

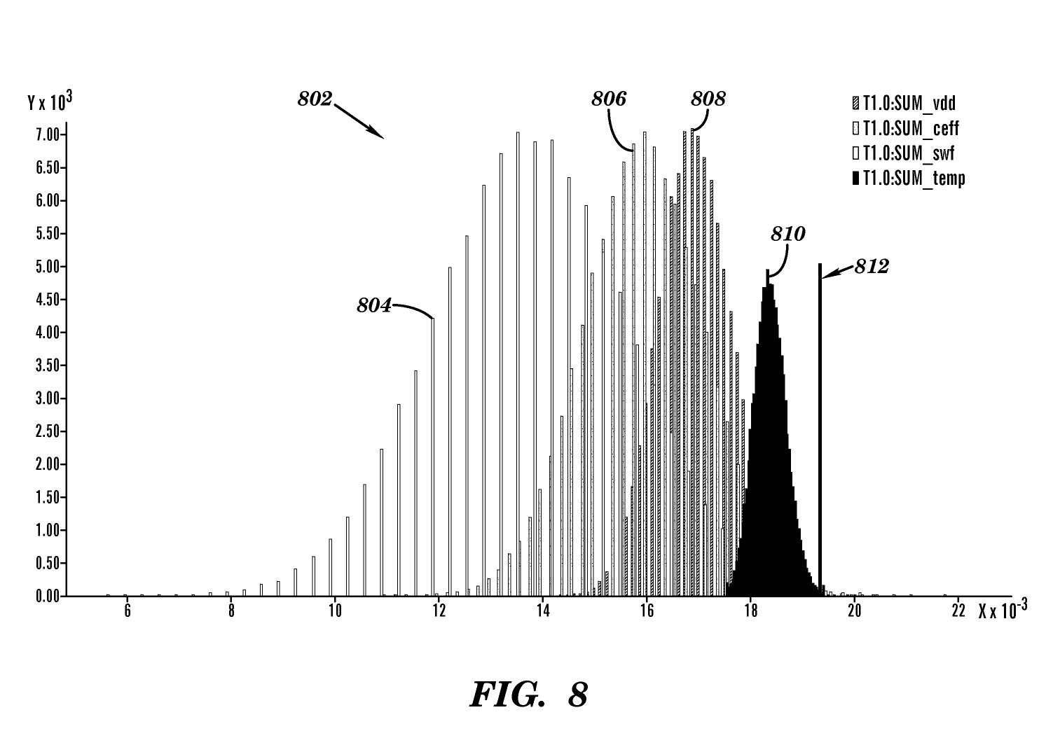

Various embodiments of the present invention contemplate modeling techniques according to which not all power affecting parameters will be subject to statistical variation in a given run of the Monte Carlo simulation. FIG. 8 is a graph illustrating representative statistical distributions of a total power consumed by a power consuming unit generated by statistically varying a plurality of the power contributing parameters, one parameter at a time, during Monte Carlo simulation, according to another embodiment of the present invention. Limited variation of parameters may be utilized when there is a lack of statistical data for a specific parameter or the power contribution of that specific parameter is negligible. The graph 802 depicted in FIG. 8 comprises four different distributions. First distribution 804 illustrates a power consumption distribution generated by the statistical analyzer program 132 with an assumption that only the VDD parameter has drifted, while other power affecting parameters remain substantially constant (for example, at 3σ). Second distribution 806 illustrates a power consumption distribution model where only the effective capacitance (C_{eff}) parameter is statistically varied, while other power affecting parameters remain substantially constant (for example, at 3σ). Similarly, third distribution 808 and fourth distribution 810 illustrate distributions generated by the statistical analyzer program 132 by statistically varying only the switching frequency (SWF) and the temperature parameters, respectively. At least one, if not all, of the statistical distributions illustrated in FIG. 8 may comprise a better power consumption estimation model, as compared to the conventional worst case analysis power consumption estimation 812 (equal to 19.4 mW, when all parameters are set at 3 σ). FIG. 8 illustrates that each power affecting parameter may have its own effect on an overall power consumption. It should be noted that each distribution in the graph 802 is a histogram of the frequency of occurrence of power consumption values constructed by the statistical analyzer program 132 as a result of Monte Carlo simulation for approximately 100,000 trials. In summary, a statistical model described herein utilizes the simulation data to estimate a parameter indicative of consumed power associated with one or more power consuming units such as a chip, a system, or a functional block. The statistical model described in various embodiments of the present invention presents an improved estimation technique, as compared to the worst case analysis technique, because it enables designers of advanced ICs to optimize not only dynamic power consumption but also static power consumption.

FIG. 9 is a block diagram of internal and external components of each of the computers of FIG. 1. Computers 106 and 120 include respective sets of internal components 800a, b and external components 900a, b. Each of the sets of internal components 800a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and microcontroller program 130 are stored on one or more of the computer-readable tangible storage devices 830 for execution by one or more of the processors 820 via one or more of the RAMs 822 (which typically include cache memory). In the embodiment illustrated in FIG. 9, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a,b also includes a R/W drive or interface 832 to read from and write to one or more portable computer-readable tangible storage devices 828 such as a CD-ROM, DVD, memory stick, magnetic tape, magnetic disk, optical disk or semiconductor storage device. The power predictor application program 129, which includes various components, such as the parameter collector program 130 and the statistical analyzer program 132, can be stored on one or more of the portable computer-readable tangible storage devices 936, read via R/W drive or interface 832 and loaded into one or more computer-readable tangible storage devices 830.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the large computer server, partly on the large computer server, as a stand-alone software package, partly on the large computer server and partly on a remote computer or entirely on the remote computer or server. In the latter scenario, the remote computer may be connected to the large computer server through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for predicting the power consumption of a semiconductor chip, the method comprising:
receiving a plurality of statistical distributions characterizing a plurality of power contributing parameters and their respective statistical correlation for a plurality of power consuming units included in the semiconductor chip; and
determining, by one or more processors, a statistical distribution characterizing the power consumption based on the received plurality of statistical distributions and based on the correlation between the power contributing parameters.

2. The method of claim 1, wherein determining a statistical distribution characterizing the power consumption comprises performing a simulation that varies at least one of the plurality of power contributing parameters.

3. The method of claim 1, further comprising, in response to receiving the plurality of statistical distributions, extracting statistical characteristics of the respective statistical distributions, wherein the statistical characteristics comprise mean and standard deviation values of the respective statistical distributions.

4. The method of claim 1, wherein receiving a plurality of statistical distributions further comprises retrieving the plurality of statistical distributions from a repository that stores data provided by a user.

5. The method of claim 1, wherein the plurality of statistical distributions comprise at least one Gaussian distribution.

6. The method of claim 2, wherein performing a simulation that varies at least one of the plurality of power contributing parameters comprises performing a Monte Carlo simulation.

7. The method of claim 6, wherein performing the Monte Carlo simulation comprises calculating dynamic power consumption and static power consumption based on the plurality of statistical distributions characterizing the plurality of power contributing parameters.

8. A computer program product for predicting the power consumption of a semiconductor chip, the computer program product comprising one or more computer-readable tangible storage devices and a plurality of program instructions stored on one or more computer-readable tangible storage devices, the plurality of program instructions comprising:
program instructions to receive a plurality of statistical distributions characterizing a plurality of power contributing parameters and their respective statistical correlation for a plurality of power consuming units included in the semiconductor chip; and
program instructions to determine a statistical distribution characterizing the power consumption based on the received plurality of statistical distributions and based on the correlation between the power contributing parameters.

9. The computer program product of claim 8, wherein the program instructions to determine a statistical distribution characterizing the power consumption comprise program instructions to perform a simulation that varies at least one of the plurality of power contributing parameters.

10. The computer program product of claim 8, further comprising program instructions to extract statistical characteristics of the respective statistical distributions, wherein the statistical characteristics comprise mean and standard deviation values of the respective statistical distributions.

11. The computer program product of claim 8, wherein the program instructions to receive a plurality of statistical distributions further comprise program instructions to retrieve the plurality of statistical distributions from a repository that stores data provided by a user.

12. The computer program product of claim 8, wherein the plurality of statistical distributions comprise at least one Gaussian distribution.

13. The computer program product of claim 9, wherein the program instructions to perform a simulation that varies at least one of the plurality of power contributing parameters comprise program instructions to perform a Monte Carlo simulation.

14. The computer program product of claim 13, wherein the program instructions to perform the Monte Carlo simulation comprise program instructions to calculate dynamic power consumption and static power consumption based on the plurality of statistical distributions characterizing the plurality of power contributing parameters.

15. A computer system for predicting the power consumption of a semiconductor chip, the computer system comprising one or more processors, one or more computer-readable storage devices, and a plurality of program instructions stored on one or more storage devices for execution by one or more processors, the plurality of program instructions comprising:
program instructions to receive a plurality of statistical distributions characterizing a plurality of power contributing parameters and their respective statistical correlation for a plurality of power consuming units included in the semiconductor chip; and
program instructions to determine a statistical distribution characterizing the power consumption based on the received plurality of statistical distributions and based on the correlation between the power contributing parameters.

16. The computer system of claim 15, wherein the program instructions to determine a statistical distribution characterizing the power consumption comprise program instructions to perform a simulation that varies at least one of the plurality of power contributing parameters.

17. The computer system of claim 15, further comprising program instructions to extract statistical characteristics of the respective statistical distributions, wherein the statistical characteristics comprise mean and standard deviation values of the respective statistical distributions.

18. The computer system of claim 15, wherein the program instructions to receive a plurality of statistical distributions further comprise program instructions to retrieve the plurality of statistical distributions from a repository that stores data provided by a user.

19. The computer system of claim 15, wherein the plurality of statistical distributions comprise at least one Gaussian distribution.

20. The computer system of claim 19, wherein the program instructions to perform a simulation that varies at least one of the plurality of power contributing parameters comprise program instructions to perform a Monte Carlo simulation.
